(19) United States
(12) Patent Application Publication
(10) Pub. No.: US 2006/0054718 A1
(43) Pub. Date: Mar. 16, 2006

(54) Water sprayer

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/940,681

(22) Filed: Sep. 15, 2004

(51) Int. Cl. A62C 13/62; F23D 14/28; B05B 7/30; A62C 13/66

(52) U.S. Cl. 239/337; 239/302; 239/351

(57) ABSTRACT

A water sprayer includes a water pump, a water accumulator for accumulating water from the water pump, a solenoid switch for controlling water output of the water accumulator, a hose nozzle assembly with a tilt angle-adjustable spray nozzle connected to the output side of the solenoid switch, and a controller for controlling operation of the water pump and the solenoid switch.

### BACKGROUND OF THE INVENTION

1. Field of the Invention

The present invention relates to a water sprayer and more particularly, to such a water sprayer that uses a water accumulator to increase the pressure of water and a solenoid switch to control output of water from the water accumulator to a spray nozzle.

2. Description of the Related Art

Conventional water sprayers are designed for different purposes. A water sprayer for watering flowers and plants is not suitable for use as a tabletop artificial fountain. A tabletop artificial fountain cannot be used for watering flowers and plants. Further, the installation of a water sprayer for watering flowers and plants is complicated and requires special techniques.

### SUMMARY OF THE INVENTION

The present invention has been accomplished under the circumstances in view. It is the main object of the present invention to provide a water sprayer, which can be used for watering flowers and plants as well as for constructing a tabletop artificial fountain. It is another object of the present invention to provide a water sprayer, which enables the user to conveniently adjust the tilt angle of the spray nozzle.

To achieve these and other objects of the present invention, the water sprayer comprises a water pump; a water accumulator adapted to accumulate compressed water from the water pump; a solenoid switch adapted to control output of water from the water accumulator; water tubes adapted to deliver water from the water pump to the water accumulator and from the water accumulator to the solenoid switch; a hose nozzle assembly for spraying water, the hose nozzle assembly comprising a holder base, the holder base comprising an opening cut through front and rear sides thereof on the middle, a rack fixedly provided in the opening at a bottom side, and two pivot holes aligned in the opening at two sides above the rack, a swivel block pivoted to the holder base, the swivel block comprising two pivot pins symmetrically provided at two opposite lateral sides thereof and respectively pivoted to the pivot holes, a gear fixedly provided at a bottom side thereof and meshed with the rack, a spray nozzle fastened to the swivel block and connected to the water outlet pipe; a water outlet pipe adapted to deliver water from the solenoid switch to the hose nozzle assembly; and a controller adapted to control the operation of the water pump and the solenoid switch.

### BRIEF DESCRIPTION OF THE DRAWINGS

FIG. 1 is a perspective view of a water sprayer according to the present invention.

FIG. 2 is an exploded view of the hose nozzle assembly for the water sprayer according to the present invention.

FIG. 3 is a schematic drawing showing adjustment of the tilt angle of the spray nozzle according to the present invention.

FIG. 4 is a schematic drawing showing one application example of the present invention.

FIG. 5 is a schematic drawing showing another application example of the present invention.

FIG. 6 is a perspective view of an alternate form of the water sprayer according to the present invention.

### DETAILED DESCRIPTION OF THE PREFERRED EMBODIMENT

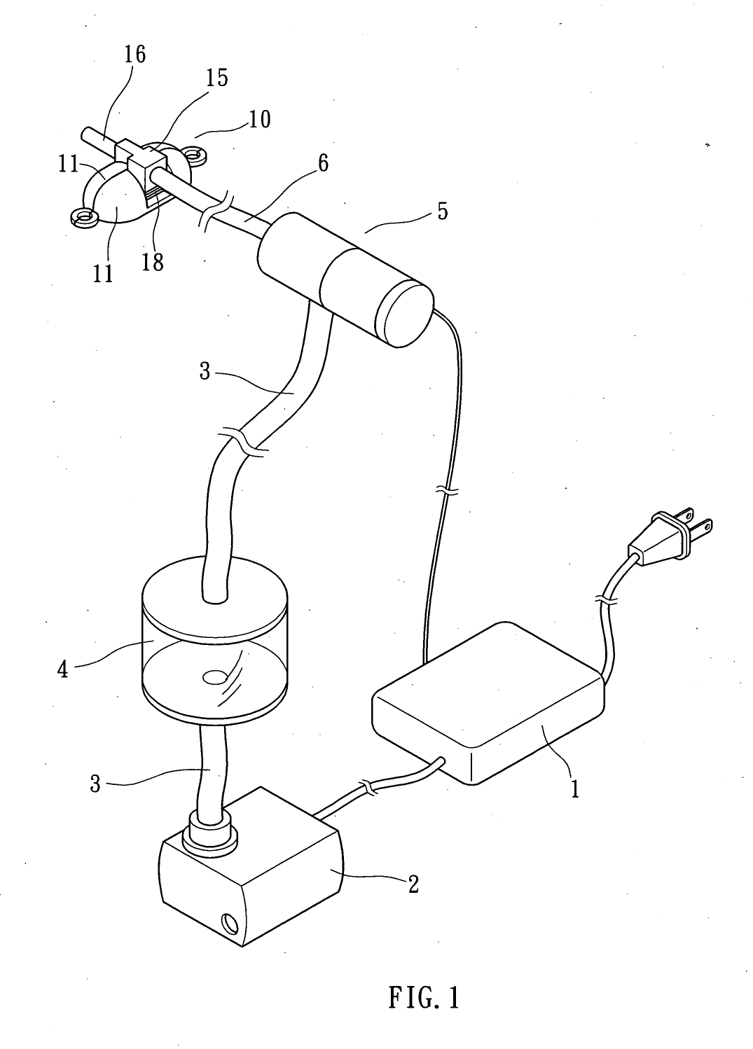

Referring to FIG. 1, a water sprayer in accordance with the present invention is shown comprising a water pump 2, a water accumulator 4 adapted to accumulate compressed water from the water pump 2, a solenoid switch 5 adapted to control output of water from the water accumulator 4, water tubes 3 adapted to deliver water from the water pump 2 to the water accumulator 4 and from the water accumulator 4 to the solenoid switch 5, a hose nozzle assembly 10 for spraying water, a water outlet pipe 6 adapted to deliver water from the solenoid switch 5 to the hose nozzle assembly 10, and a controller 1 adapted to control the operation of the water pump 2 and the solenoid switch 5.

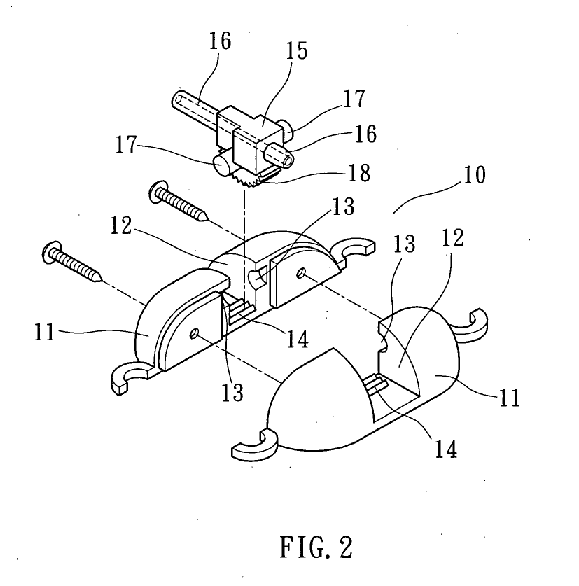

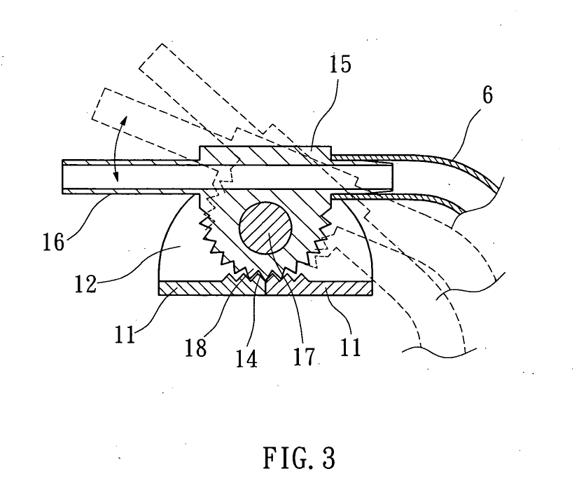

Referring to FIGS. 2 and 3, the hose nozzle assembly 10 is comprised of a holder base 11, a swivel block 15, and a spray nozzle 16. The holder base 11 is to be affixed to support means at the desired place, comprising an opening 12 cut through the front and rear sides thereof on the middle, a rack 14 fixedly provided in the opening 12 at the bottom side, and two pivot holes 13 aligned in the opening 12 at two sides above the rack 14. The swivel block 15 comprises two pivot pins 17 symmetrically provided at the two opposite lateral sides thereof and respectively pivoted to the pivot holes 13, a gear 18 fixedly provided at the bottom side thereof and meshed with the rack 14. The spray nozzle 16 is fastened to the swivel block 15 and connected to the water outlet pipe 6. After installation of the hose nozzle assembly 10, the user can turn the swivel block 15 relative to the holder base 11 to adjust the tilt angle of the spray nozzle 16.

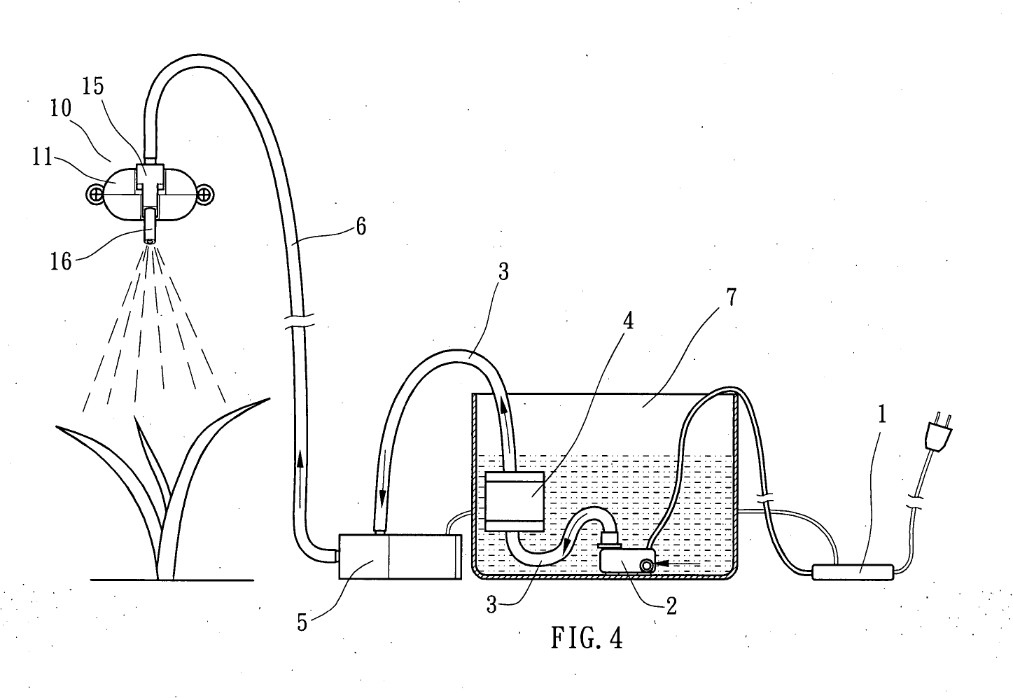

FIG. 4 shows an application example of the present invention. As illustrated, the water pump 2 and the water accumulator 4 are put under water in a water tank 7, the controller 1 and the solenoid switch 5 are set outside the water tank 7, and the water outlet pipe 6 is extended to the garden so that the user can use the hose nozzle assembly 10 to water flowers and plants.

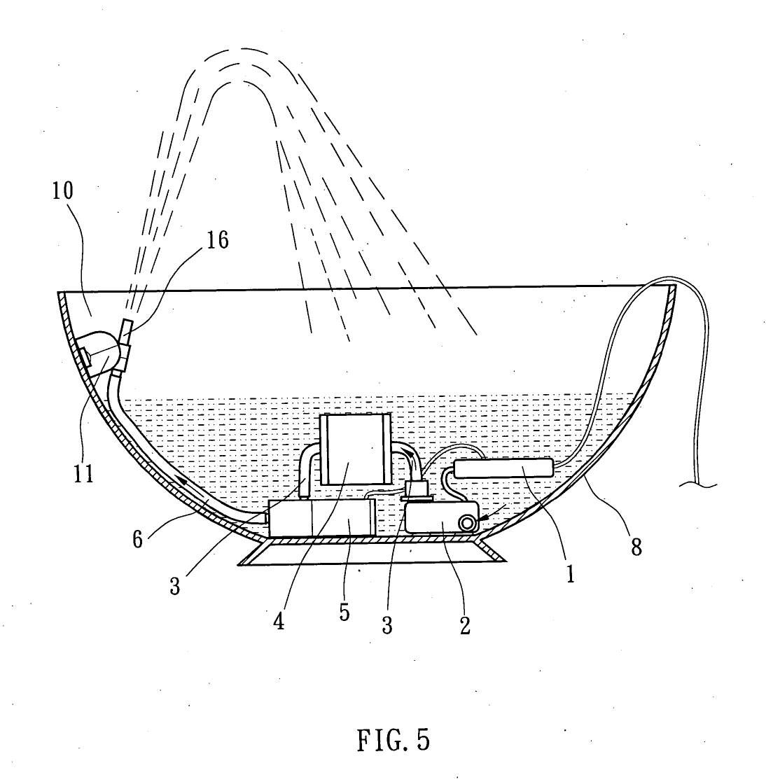

FIG. 5 shows another application example of the present invention. As illustrated, the whole assembly of the water sprayer is arranged in a watertight status and set under water in a bowl-like water container 8, and controlled to produce a spring of water.

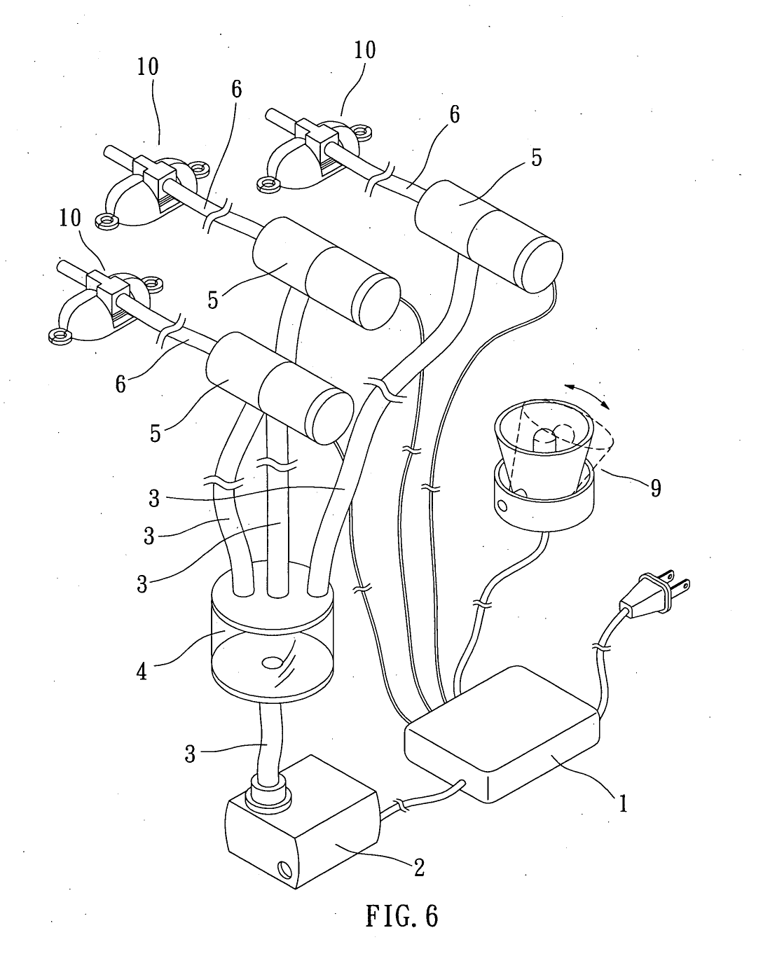

FIG. 6 shows an alternate form of the present invention. According to this embodiment, multiple solenoid switches 5 are connected in parallel to the water accumulator 4, multiple hose nozzle assemblies 10 are respectively connected to the solenoid switches 5 by respective water outlet pipes 6, and an illuminator 9 is provided and controlled by the controller 1 to produce light for illumination.

A prototype of water sprayer has been constructed with the features of FIGS. 1˜6. The water sprayer functions smoothly to provide all the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A water sprayer comprising:
a water pump;
a water accumulator adapted to accumulate compressed water from said water pump;
a solenoid switch adapted to control output of water from said water accumulator;
water tubes adapted to deliver water from said water pump to said water accumulator and from said water accumulator to said solenoid switch;
a hose nozzle assembly for spraying water, said hose nozzle assembly comprising a holder base, said holder base comprising an opening cut through front and rear sides thereof on the middle, a rack fixedly provided in said opening at a bottom side, and two pivot holes aligned in said opening at two sides above said rack, a swivel block pivoted to said holder base, said swivel block comprising two pivot pins symmetrically provided at two opposite lateral sides thereof and respectively pivoted to said pivot holes, a gear fixedly provided at a bottom side thereof and meshed with said rack, a spray nozzle fastened to said swivel block and connected to said water outlet pipe;
a water outlet pipe adapted to deliver water from said solenoid switch to said hose nozzle assembly; and
a controller adapted to control the operation of said water pump and said solenoid switch.

2. The water sprayer as claimed in claim 1, further comprising a plurality of secondary solenoid switches connected in parallel to said water accumulator, a plurality of secondary hose nozzle assemblies respectively connected to said secondary solenoid switches, and a plurality of secondary water outlet pipes respectively connected between said secondary solenoid switches and said secondary hose nozzle assemblies.

3. The water sprayer as claimed in claim 1, further comprising an illuminator controlled by said controller to produce light.
